(19) United States
(12) Patent Application Publication
(10) Pub. No.: US 2015/0166322 A1
(43) Pub. Date: Jun. 18, 2015

(54) DRINK AND CONFECTION DISPENSING MACHINE

(71) Applicant: Frobot, Inc., Lewisburg, WV (US)

(72) Inventors: Jeremiah O'Sullivan, Lewisburg, WV (US); Alexander S. Farley, Mississauga (CA); Melissa A. Nelson, Hawley, PA (US); Melissa K. O'Sullivan, Lewisburg, WV (US)

(21) Appl. No.: 14/569,394

(22) Filed: Dec. 12, 2014

Related U.S. Application Data
(63) Continuation-in-part of application No. 14/267,898, filed on May 1, 2014, now abandoned.
(60) Provisional application No. 61/818,391, filed on May 1, 2013.

(51) Int. Cl. A47F 1/00

(52) U.S. Cl. CPC B67D 7/22; B67D 7/02; B67D 7/84; B67D 7/78; B67D 7/86; A23G 9/28

(57) ABSTRACT

A machine for dispensing liquids and/or frozen confections, includes a housing that houses a manually operated machine; a digital touch screen that is disposed on an exterior surface of the housing, the digital touch screen interfacing with a computer programmed to accept instructions from the digital touch screen to automate dispensing by controlling the actuators and the one or more manually operated machines according to the instructions received; one or more actuators disposed on the interior surface of the housing; for each actuator, a connection piece that is configured at its proximal end to attach to the actuator and that is configured on its distal end to receive a handle of the one or more manually operated machines; a product dispensing chute that is disposed on the interior surface of the housing and that is configured to receive product from the one or more dispensing mechanisms; and a counter surface.

### CROSS REFERENCE TO RELATED APPLICATIONS

This application is a continuation-in-part of U.S. application Ser. No. 14/267,898 filed on May 1, 2014, which is a non-provisional application of U.S. Application No. 61/818,391, filed on May 1, 2013. The entire contents of the foregoing applications are hereby incorporated herein by reference in their entirety.

### TECHNICAL FIELD

The present invention relates to devices, systems and methods of vending equipment for dispensing drink and/or confections.

### BACKGROUND

Purchase transactions have traditionally been conducted by utilizing coin based as well as paper based currency. In recent times, with the advent of digital based currency and web based consumer credit accounts that may be accessed via a credit card, debit card, mobile communications device, online credit account or similar based device or mechanism, it has become more desirable to provide for the use of digital based currency in vending equipment. However, traditional vending machines, due to their complexity, are often times very costly to develop and/or purchase and operate.

What is needed are devices, systems and methods for improving the vending equipment for dispensing drink and/or confections.

### SUMMARY

In one embodiment of the present invention, a machine for dispensing liquids and/or frozen confections can include a housing that is configured to house one or more manually operated machines for dispensing drinks and/or frozen confections, the housing having an interior surface that interfaces with the one or more manually operated machines and having an exterior surface for interfacing with a user. The machine can include one or more product dispensing chutes disposed on the interior surface of the housing that is configured to receive product from one or more dispensing mechanisms of the one or more manually operated machines. The machine can include one or more actuators that is disposed on the interior surface of the housing, the one or more actuators being configured to interact with the at least one manually operated machine and a computer programmed to accept instructions such that dispensing of one or more dispensing mechanisms of the at least one manually operated machine is automated to dispense an amount of liquid and/or frozen confections according to instructions received from the computer.

In another embodiment, a machine for dispensing liquids and/or frozen confections can include a housing that is configured to house one or more manually operated machines for dispensing drinks and/or frozen confections, the housing having an interior surface that interfaces with the one or more manually operated machines and having an exterior surface for interfacing with a user. The machine can include a user interface that is disposed on the exterior surface of the housing, the user interface interfacing with a computer programmed to accept instructions from the user interface to automate dispensing. The machine can include one or more actuators disposed on the interior surface of the housing, the one or more actuators operable in response to instructions input by the user via the user interface. The machine can include, for each actuator, a connection piece that is configured at its proximal end to attach to the actuator and that is configured on its distal end to receive a handle of the one or more manually operated machines such that dispensing of one or more dispensing mechanisms of the at least one manually operated machine is automated. The machine can include a product dispensing chute that is disposed on the interior surface of the housing and that is configured to receive product from the one or more dispensing mechanisms. By the user touching the user interface to indicate a type and amount of liquid and/or frozen confections desired, the user interface can send instructions to the computer, and the computer can cause the type and amount of liquid/frozen confection desired by the user to be discharged from the product dispensing chute through control of the computer of: the manually operated machine, the one or more actuators, and the one or more dispensing mechanisms.

In an embodiment of the invention, a method of serving drinks and/or frozen confections can include housing the drinks and/or frozen confections inside a manually operated machine for dispensing drinks and/or frozen confections, the manually operated machine being located in the housing. The housing can include a computer, a user interface, one or more actuators, one or more product dispensing mechanisms, and one or more payment devices, and the computer is programmed with software to control the actuators and payment devices in response to instructions entered by a user on the user interface, and the user can select a type and quantity of the drinks and frozen confections the user would like.

Additional features, advantages, and embodiments of the invention are set forth or apparent from consideration of the following detailed description, drawings and claims. Moreover, it is to be understood that both the foregoing summary of the invention and the following detailed description are examples and intended to provide further explanation without limiting the scope of the invention as claimed.

### BRIEF DESCRIPTION OF THE DRAWINGS

Other objects and advantages will become apparent from the attached drawings in which:

FIG. 1 is an isometric view of the Frozen Confectionary Vending Machine illustrating an embodiment of the present invention.

FIG. 2 is a frontal view of the Frozen Confectionary Vending Machine of FIG. 1.

FIG. 3 is a left side view of the Frozen Confectionary Vending Machine of FIG. 1.

FIG. 4 is a top view of the Frozen Confectionary Vending Machine of FIG. 1.

FIG. 5 is an internal isometric view of the Frozen Confectionary Vending Machine of FIG. 1.

FIG. 6 shows a manually operated frozen confectionary dispensing machine, according to an embodiment of the invention.

FIG. 7 shows a manually operated frozen confectionary dispensing machine, according to an embodiment of the invention.

FIG. 8 is a close-up view of the handles of the manually operated machine of FIG. 7.

FIG. 9 shows a connection piece and an actuator of a housing interfacing with a handle of a manually operated machine.

FIG. 10 shows a frontal view of the Frozen Confectionary Vending Machine illustrating an embodiment of the present invention.

FIG. 11 shows an inside of a product dispensing chute, according to an embodiment of the invention.

FIG. 12 shows an inside of a product dispensing chute, according to another embodiment of the invention.

FIG. 13 shows a close-up isometric view of the Frozen Confectionary Vending Machine illustrating an embodiment of the present invention.

FIG. 14 shows a close-up isometric view of the Frozen Confectionary Vending Machine having a drainage grill, illustrating an embodiment of the present invention.

FIG. 15 shows an internal isometric view of the Frozen Confectionary Vending Machine showing a waste tank, illustrating an embodiment of the present invention.

FIG. 16 shows an enlarged view of a grill, according to an embodiment of the invention.

FIG. 17 shows an enlarged view of a grill, according to an embodiment of the invention.

### DETAILED DESCRIPTION

Some embodiments of the current invention are discussed in detail below. In describing embodiments, specific terminology is employed for the sake of clarity. However, the invention is not intended to be limited to the specific terminology and examples selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

Embodiments of the invention may involve use of a computer. As used herein, the term “computer” is intended to have a broad meaning that may be used in computing devices such as, e.g., but not limited to, standalone or client or server devices. The computer may be, e.g., (but not limited to) a personal computer (PC) system running an operating system such as, e.g., (but not limited to) MICROSOFT® WINDOWS® NT/98/2000/XP/Vista/Windows 7/8/8.1 etc. available from MICROSOFT® Corporation of Redmond, Wash., U.S.A. or an Apple computer executing MAC® OS from Apple® of Cupertino, Calif., U.S.A. Computer configurations running other operating systems such as Linux and ChromeOS are also contemplated within the scope of the invention. However, the invention is not limited to these platforms. Instead, the invention may be implemented on any appropriate computer system running any appropriate operating system. Further, the invention may be implemented on a cloud computing unit and mobile devices. In one embodiment, the invention may be a cloud-based SaaS platform and able to be accessed on computers, tablets, ipads, smartphones, etc.

After reading this description, it will become apparent to a person skilled in the relevant art(s) how to implement the invention using other computer systems and/or architectures.

Some embodiments of the invention can provide an apparatus and/or system that can retrofit existing handle-operated manual machines for dispensing frozen confectionary via a digital interface, and the like. For example, some embodiments of the invention can be a frozen confectionery vending machine based on the utilization of a commercially available, manually operated, frozen confectionery dispensing machine that encloses the machine into a secured housing, and provides an automated dispensing interface and function that is activated upon touchscreen prompt or the completion of a purchase transaction.

Automated dispensing can be achieved by communicating information from end purchaser through a digital interface and a payment device to an embedded computer. The computer can communicate with various financial institutions for the purpose of payment validation of the end user payment information. Upon purchase validation, the computer can communicate with an actuator, which in turn can activate the dispensing mechanism on the manually operated frozen confectionary dispensing machine. Upon activation of the dispensing mechanism, frozen confection can be dispensed through a chute that leads the dispensed product from the interior of the secured housing to the exterior of the secured housing and into a cup, cone, or other substance collection device that the purchaser places below the chute. The cup, cone, or other substance collection device can reside on a platform of a digital scale. As the cup, cone, or other substance collection device is filled, the digital scale can communicate the weight of dispensed confection to the computer. When the weight of the dispensed confection reaches the purchased amount, the computer can disengage or retract the position of the actuator, thus terminating the dispensing of the frozen confection.

The Frozen Confectionary Vending Machine can also provide means for the storage of the cups, cones, or other substance collection devices, eating utensils, napkins and/or any other items deemed necessary to provide a satisfactory end user experience.

Embodiments of the invention relate to vending equipment from which a food product and/or confections are dispensed for a fixed monetary exchange. The equipment can take many forms, creating a retail purchase transaction, and supplying a desirable product to the end user. In this application, the invention is described for use with a frozen confectionary dispensing machine, but this is by way of illustration and not by way of limitation. For example, other products, such as soda, pudding, slushees, etc., can be dispensed with embodiments of the present invention.

Embodiments of the invention create a solution to the issue of a high cost entry point for traditional vending machines. In an embodiment, this problem can be solved by substantially reducing the entry point cost to manufacture and operate because of its utilization of widely available, industry standard components, control systems, operating systems, and software that are readily available and are cost effective in their purchase, assembly, installation and operation. Embodiments allow for the ability to expand the intended marketplace at an accelerated pace, due to the lower cost application. Utilizing industry standard components that are readily available and cost effective allows for ease of maintenance, repair, and downtime minimization.

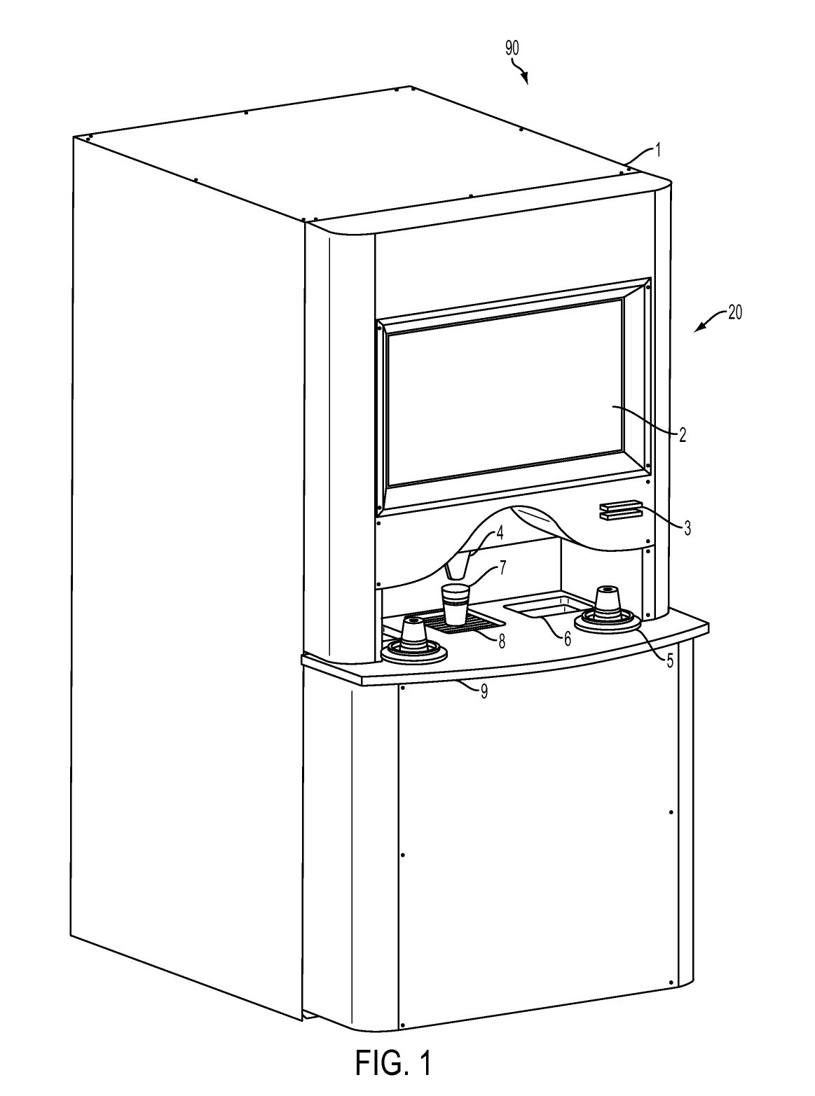

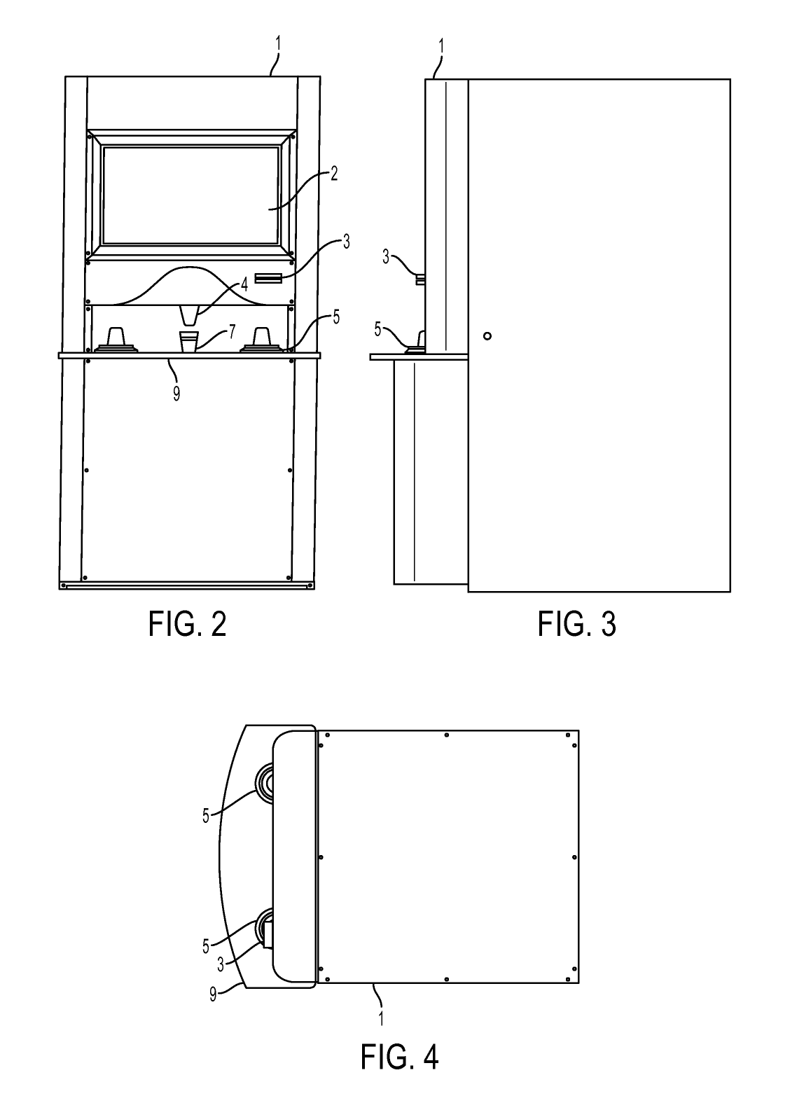

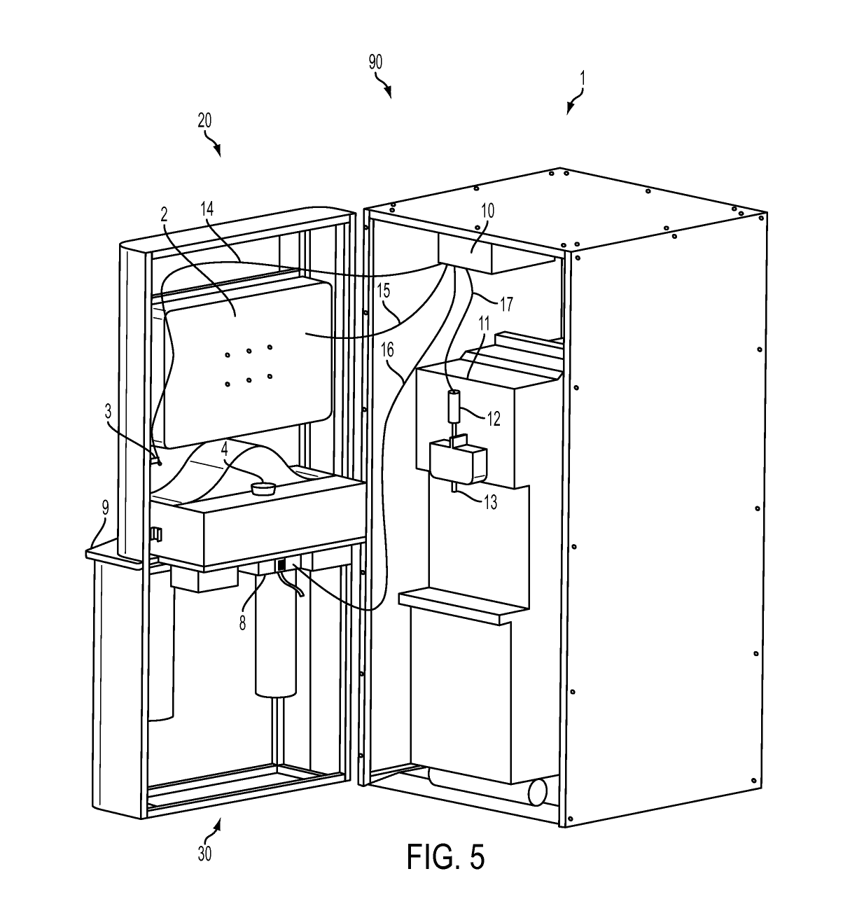

For purposes of illustration but not by way of limitation, FIG. 1 shows a housing 1 containing components of an embodiment. This housing 1 shape and form can be configured in a variety of ways in order to best serve the marketplace, item dispensed, installed location, etc. FIG. 5 shows that a machine 90 for dispensing liquids and/or frozen confections can include a housing 1 that is configured to house one or more manually operated machines 11 for dispensing drinks and/or frozen confections. The housing 1 can have an interior surface 30 that interfaces with the one or more manually operated machines 11 and can have an exterior surface 20 for interfacing with a user.

In an embodiment, the machine 90 can include one or more product dispensing chutes 4 disposed on the interior surface 30 of the housing 1. The chutes 4 can be configured to receive product from the one or more dispensing mechanisms 13. As seen in FIG. 5, the machine 90 includes a commercially available manually operated frozen confectionary dispensing machine 11 that includes a product dispensing mechanism 13.

As shown in FIG. 1, the machine 90 can include a digital interface 2. The digital interface 2 can be a digital touch screen interface and it can be a digital touch screen interface display. Other digital interfaces can include push buttons, a keypad, a keyboard and/or wireless connections. FIG. 1 shows that a digital interface 2 is disposed on the exterior surface 20 of the housing 1. At the beginning of a transaction, a user can begin interaction with the machine 1 through visual, auditory, and/or written instructions displayed on the digital interface 2. The user will be able to customize their product order based on choices made pertaining to such aspects of product like size, flavor, and additional ingredients. The user can make selections by touching the screen of the digital interface 2. The digital interface 2 can sense the user's choices and communicate these choices to the embedded computer 10 (see FIG. 5) via the digital interface cable 15. The digital interface 2 can interface with the computer 10 can be programmed to accept instructions from the digital touch screen to automate dispensing by controlling actuators 12 and the at least one manually operated machine according to the instructions received.

According to an embodiment, a cup, cone, or other substance collection device 7 can be provided on the exterior surface of the housing 1. Additionally, it is also possible to provide a holder to contain a plurality of cups, cones, or other substance collection devices 5, a holder to contain a plurality of disposable napkins, eating utensils, food toppings and any other items to complete the experience 6, and a counter surface on which to place purchased items 9.

As shown in FIG. 5, the machine 90 can include a computer 10. The computer can be an embedded computer 10. The computer 10 can perform various calculations and configurations in order to determine the appropriate product configuration prior to dispensing.

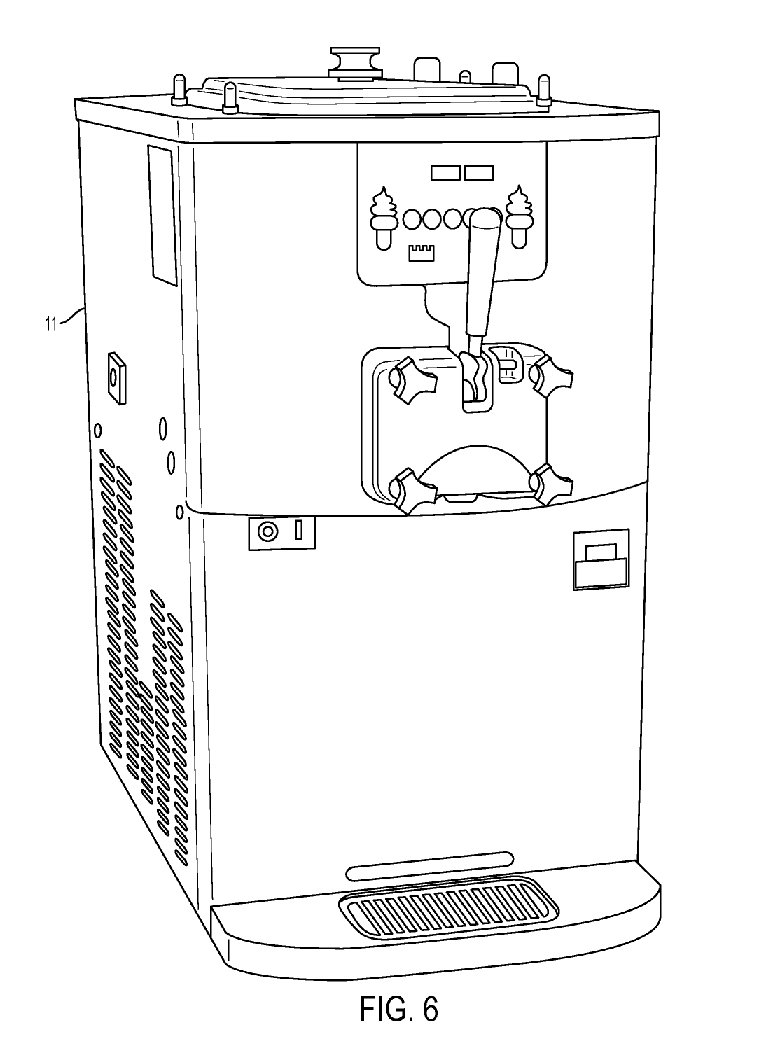

As shown in FIG. 5, the housing 1 can include one or more actuators 12 disposed on the interior surface of the housing 1 and configured to interact with the at least one manually operated machine 11, according to instructions received from the computer. The actuators 12 can be disposed and configured such that dispensing of one or more dispensing mechanisms of the at least one manually operated machine 11 is automated. An actuator cable 17 can be used to transmit instructions from the computer to the actuators 12. FIG. 6 shows an example of the at least one manually operated machine 11. According to embodiments, the actuators 12 can comprise linear actuators, such as pneumatic cylinders or linear motors.

As shown in FIG. 1, the housing can include a counter surface 9, which provides an approximately level surface with sufficient room to contain a plurality of cups or other substance collection devices. The counter surface 9 can be located below the one or more product dispensing chutes, such that a cup 7 and/or other substance collection device is capable of being placed on top of the counter surface and below the product dispensing chute.

According to an embodiment, by the user touching the digital interface 2 to indicate the type and amount of liquid and/or frozen confections desired, the digital interface 2 sends instructions to the computer 10. Upon receiving the instructions, the computer causes the type and amount of liquid/frozen confection desired by the user to be discharged from the product dispensing chute 4 through the computer's control of the manually operated machine via the one or more actuators 12, and their intersection with the one or more dispensing mechanisms.

In an embodiment, the machine 90 can further include one or more payment devices 3, such as a credit card reader, disposed on the exterior surface 20 of the housing 1. The machine 90 can further include means for transmitting data from the payment devices 3 to the computer 10. For example, a payment connection device can be configured to transmit data from the payment devices 3 to the computer. The payment connection device can be, but is not limited to, a payment device cable 14. A user may acquire liquid and/or frozen confectionary goods by using the payment device 3, which then informs the computer that payment has happened. Furthermore, for purposes of illustration but not by way of limitation, a payment device 3 is shown in FIG. 1 as a singular unit, however a plurality of payment device(s) 3 may be configured as necessary to provide additional methods of payments. Once appropriate product configuration is determined by the embedded computer 10, the embedded computer 10 will communicate via digital interface cable 15, data, to display pricing information to the end user via the digital interface 2. It will also initiate the purchase function routine which will guide the end user to initiate purchase transaction though the payment device 3. The payment device 3 will communicate, via payment device cable 14, the necessary payment data, to the embedded computer 10. The embedded computer 10 will communicate with various financial or payment processing institutions for the purpose of financial validation of the end user payment information.

In an embodiment, the machine 90 can further include a digital scale 8, which monitors the amount of liquid and/or frozen confections dispensed by the dispensing mechanism 13 through the dispensing chute 4 by monitoring the weight of the product. The machine 90 can include means for transmitting data between the digital scale 8 and the computer 10. For example, a scale connection device can be configured to transmit data between the digital scale 8 and the computer 10. The scale connection device can be, but is not limited to, a digital scale cable 16. The digital scale 8 can be embedded in the countertop and directly below the dispensing chute. The digital scale 8 can send information to the computer 10 that the amount of liquid and/or frozen confections desired by the user has been dispensed such that the computer causes the dispensing mechanism to stop dispensing liquid and/or frozen confections. In an embodiment, the digital scale 8 can send the information to the computer 10 by means of a digital scale cable 16. The machine for distributing drinks and and/or frozen confections can be a machine for distributing ice cream and/or frozen custards.

Upon validation of end user payment information, the embedded computer 10 can communicate, via the actuator cable 17, various data and power to the actuator 12, causing the actuator 12 to engage the dispensing mechanism on the manually operated frozen confectionary dispensing machine 11, initiating the dispensing of the frozen confectionary from the product dispensing mechanism 13. Frozen confectionary can travel through product dispensing chute 4, and fill cup, cone, or other substance collection device 7 that has been placed, by the end-user, on to the digital scale 8. During the dispensing cycle, the digital scale 8 can communicate, via digital scale cable 16, weight information, to the embedded computer 10. Embedded computer 10 can monitor in real time, the weight of dispensed product so as to determine when to terminate dispensing product based on predetermined weight as a result of user product configuration. When a dispensed product weight matches a predetermined weight as a result of the user product configuration, the embedded computer 10 can communicate, via actuator cable 17, to the actuator 12, a termination command, thus causing the actuator 12 to move the dispensing mechanism to the closed position, thereby terminating product dispensing.

A variety of security mechanisms within the computer's software can also be able to both prevent and detect efforts by the end user from manipulating the scale measurements to defraud the machine and receive more dispensed product than purchased. For purposes of illustration and explanation but not by way of limitation, if the monitored weight drops at any point during the dispensing cycle, the software will be able to terminate product dispensing. This is to prevent the end user from manipulating the scale measurements in an effort to defraud the invention and receive more dispensed product than purchased.

The above-described embodiments can be used to automate dispensing from the C707 single flavor Taylor machine as shown in FIG. 6. The C707 machine can be available from Taylor Equipment Distributors, Inc. having an address of 1595 Cabin Branch Drive, Cabin Branch Distribution Center, Landover, Md. 20785. As can be seen from FIG. 6, the single flavor Taylor machine has one handle, one draw valve, and one freezing cylinder as it only serves one flavor of product at a time. The system created around this machine is described as one embodiment of the application, however, other embodiments can be configured for use with other dispensing machines.

The design using the single flavor machine as shown in FIG. 6 can automate dispensing by removing the single handle/lever completely and connecting the actuator 12 directly to the draw valve. Thus, the actuator 12 can connect to a draw valve of the at least one manually operated machine 11.

Some embodiments of the present invention have several substantial advantages including:

(1) Creating a solution to the issue of a high cost entry point vending machines by its utilization of widely available, industry standard components, control systems, operating systems, and software that are readily available and cost effective in their purchase, assembly, installation and operation.

(2) Creating an automated solution for an otherwise manual operation of dispensing a frozen confectionary, utilizing a digital scale 8 for measurement, payment processing, and a graphical user interface conveyed via a touch screen display 2.

(3) Utilizing proprietary software mechanisms to terminate product dispensing if the monitored weight drops at any point during the dispensing cycle. This is to prevent the end user from manipulating the scale measurements in an effort to defraud the machine and receive more dispensed product than purchased.

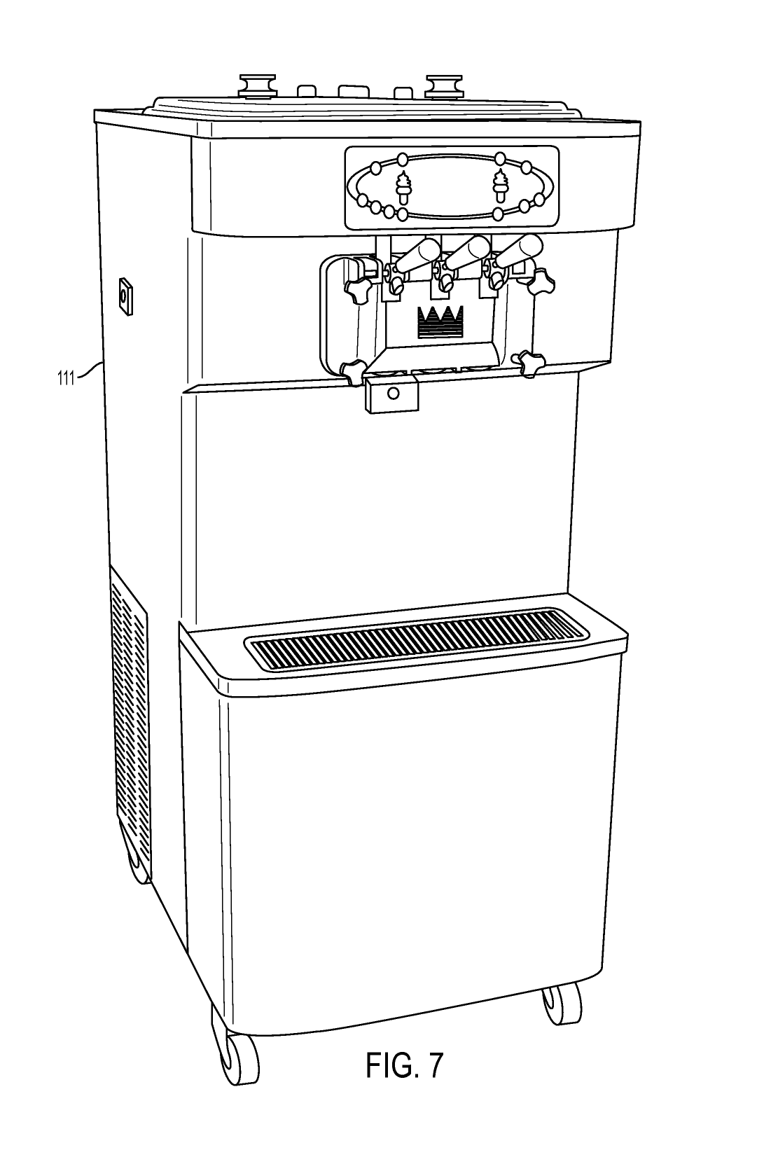

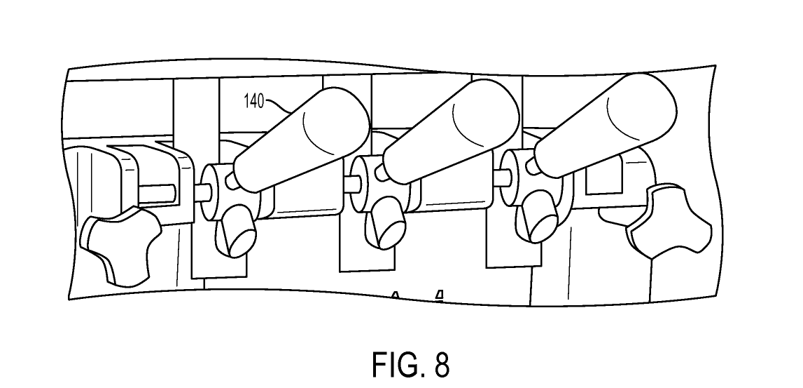

In another embodiment of the invention, as shown in FIG. 7, the manually operated machine to be automated can be a machine 111, which features two flavor hoppers at the top, and three handle/valves to dispense the two flavors plus the combination (or swirl) of the two flavors. In an embodiment, the machine 111 can be a Taylor C716. The Taylor C716 machine can be available from Taylor Equipment Distributors, Inc. having an address of 1595 Cabin Branch Drive, Cabin Branch Distribution Center, Landover, Md. 20785. FIG. 8 shows the three handles/valves in greater detail.

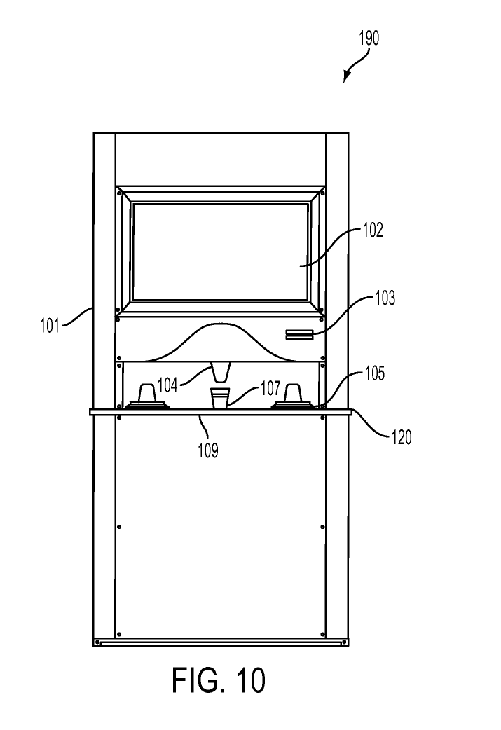

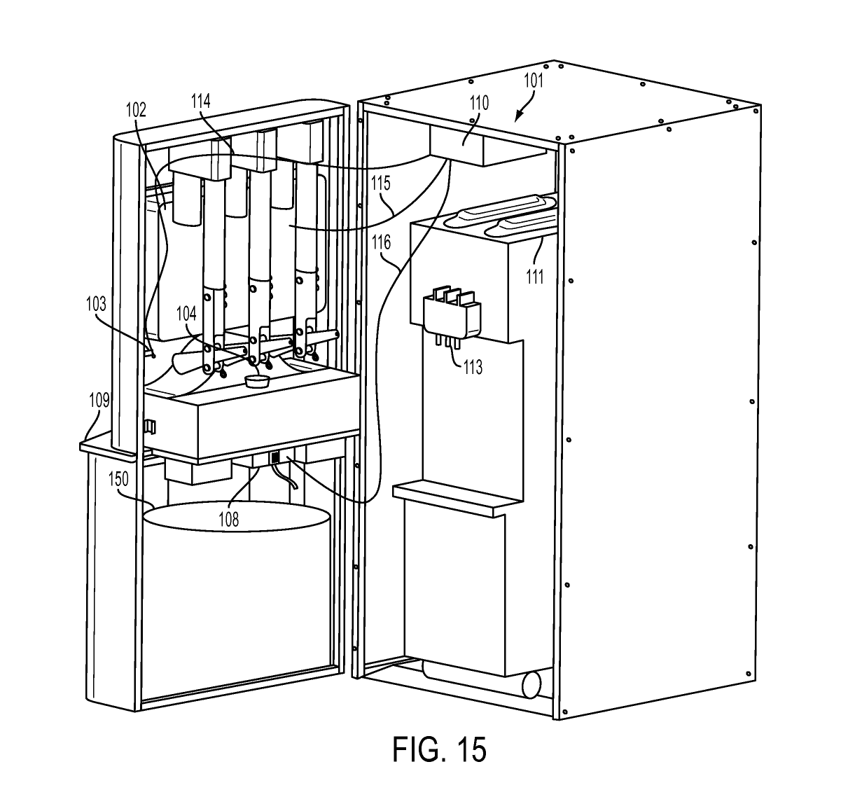

Referring to FIG. 10, a machine 190 for dispensing liquids and/or frozen confections can include a housing 101 that is configured to house one or more manually operated machines 111 for dispensing drinks and/or frozen confections. Referring to FIG. 15, the housing 101 can have an interior surface 130 that interfaces with the one or more manually operated machines 111 and can have an exterior surface 120 for interfacing with a user.

The machine 190 can include a digital interface 102 that can be disposed on the exterior surface 120 of the housing 101. The digital interface 102 can be a digital touch screen interface and it can be a digital touch screen interface display. Other digital interfaces can include push buttons, a keypad, a keyboard, and/or wireless connections. The digital touch screen 102 can interface with a computer 110 programmed to accept instructions from the digital touch screen 102 to automate dispensing by controlling at least one actuator 112, which in turn operates the at least one manually operated machine 111, according to the instructions received.

FIG. 10 shows a digital touch screen 102 that is disposed on the exterior surface 120 of the housing 101. At the beginning of a transaction, a user can begin interaction with the machine 101 through visual, auditory and written instructions displayed on the digital touch screen 102. The user will be able to customize their product order based on choices made pertaining to such aspects of product like size, flavor, and additional ingredients. The user can make selections by touching the digital touch screen 102. The digital touch screen 102 can sense the user's choices and communicate these choices to the embedded computer 110 via a digital interface cable 115. The digital touch screen 102 can interface with a computer 110 programmed to accept instructions from the digital touch screen 102 to automate dispensing by controlling the at least one actuator 112 and the at least one manually operated machine 111 according to the instructions received.

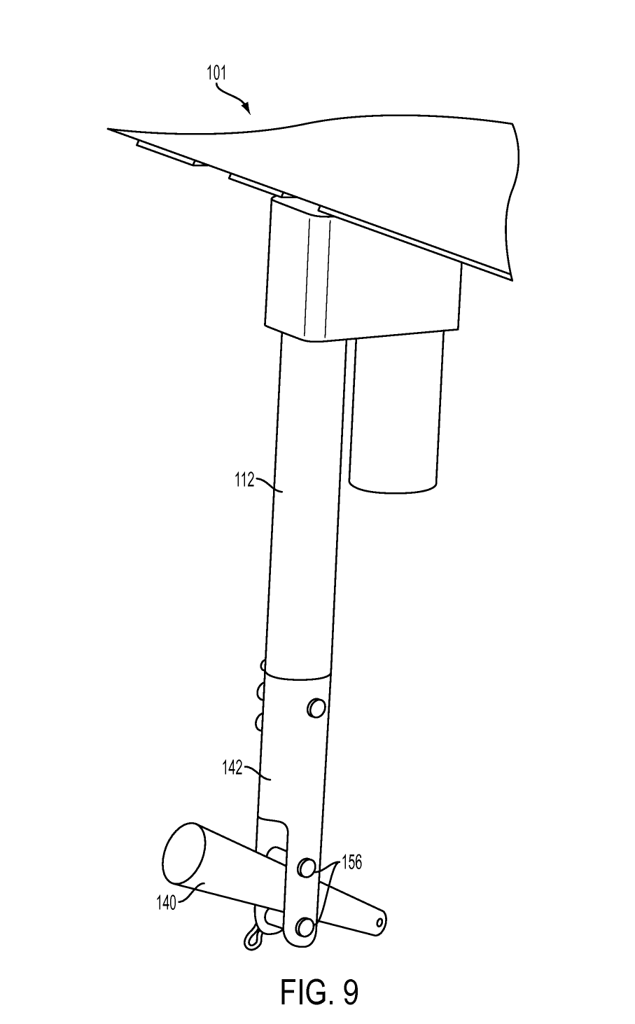

FIG. 9 shows that the machine 190 can include one or more actuators 112 disposed on the interior surface 130 of the housing 101. Each actuator 112 can be connected to the housing 101 on one end and connected to a connection piece 142 on the other end. An embodiment configured to be used with the multiflavor C716 machine can automate dispensing by connecting the actuator 112 directly to the handle 140 using connection piece 142, instead of connecting directly to the draw valve (as was done with the single flavor C707). This design can allow for seamless connection of the invention to the machine 111, without modifying any of the components of the machine 111. Thus, an embodiment of the present invention provides an apparatus for seamlessly (noninvasively/no cutting) connecting the actuator 112 to the handle/lever 140 of commercially available soft serve machine 111 and controlling/automating dispensing function of commercially available soft serve machine.

The handle 140 represents the handle on the machine 111. The actuator 112 can correspond to actuator 12 described previously. The connection piece 142 can include one or more pins 156 that interface with the handle 140. The pins 156 can allow for the handle 140 to be securely grasped by the connection piece 142 during the dispensing process.

Thus, for each actuator 112, a connection piece 142 can be configured at its proximal end to attach to the actuator 112 and can be configured at its distal end to receive a handle 140 of the one or more manually operated machines 111. The actuator 112 can move the handle 140 between closed and dispensing positions based on instructions received from the computer 110, to automate operation of the machine. This configuration allows for automated dispensing of one or more dispensing mechanisms 113 of the at least one manually operated machine 111.

Referring to FIG. 10, the product dispensing chute 104 can correspond to a product dispensing chute 4 described previously. Upon activation of the manually operated frozen confectionary dispensing machine dispensing mechanism 113, frozen confection can be dispensed through a chute 104 that leads the dispensed product from the interior surface 130 of the secured housing 101 to the exterior surface 120 of the secured housing 101 and into a cup, cone, or other substance collection device that the purchaser places below the chute 104. The machine 190 can include a product dispensing chute 104 that is disposed on the interior surface 130 of the housing 101 and that is configured to receive product from the one or more dispensing mechanisms 113.

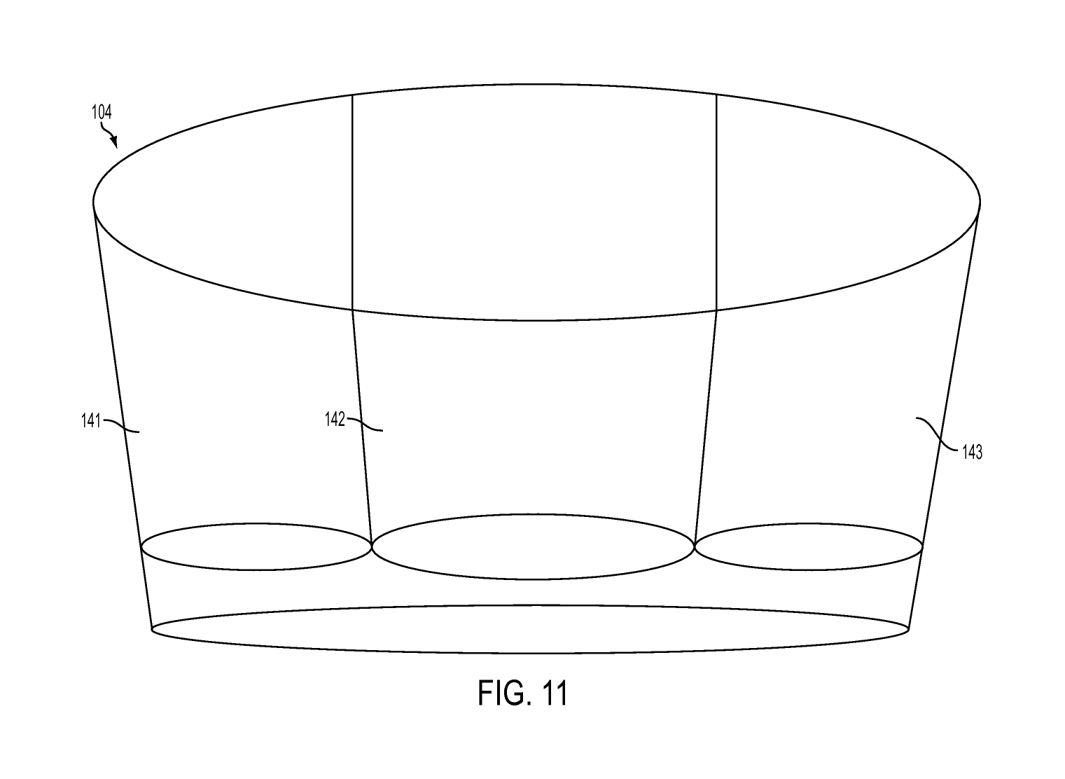

As shown in FIG. 11, the product dispensing chute 104 can include multiple canals embedded within single dispensing chute 104 where multiple canals 141, 142, 143 converge to a single mouth over recessed serving area. The product dispensing chute 104 can include the multiple embedded canals 141, 142, 143 for isolating the multiple flavors from each other to prevent undesired flavor mixing. The canals can all converge over one dispense area. This is a valuable design attribute because it could be confusing for an unfamiliar/first time customer to have three different dispense chutes and three separate serving areas to a place a cup. This can also enable a much simpler and cost effective system by using one serving area/drain pan area/digital scale rather than having three of these (e.g., one for each chute).

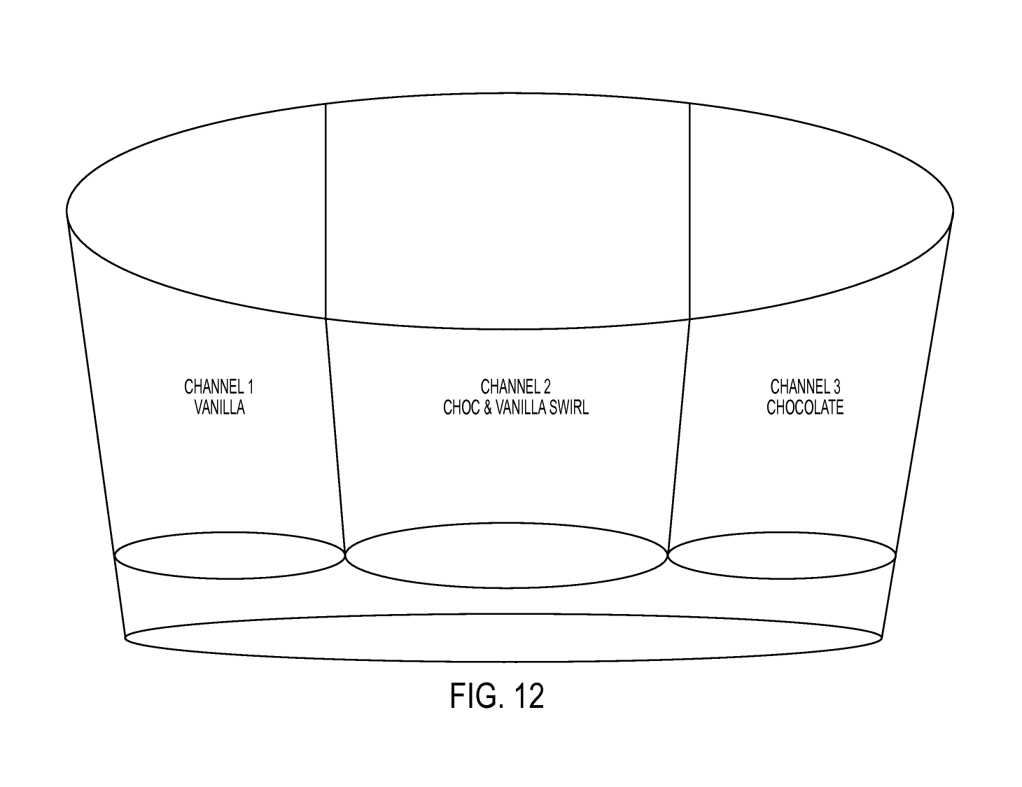

As shown in FIG. 12, a product dispensing chute 104 can be configured such that each flavor requires a separate product dispensing chute to prevent inadvertent flavor mixing or flavor contamination during the dispense process. For example, a customer ordering vanilla could have their product protected against any residual chocolate from a prior order. Thus, three separate product chutes can be provided to isolate and protect each flavor path.

The machine 190 can include a counter surface 109 disposed on the exterior surface of the housing 101. The counter surface 109 can provide an approximately level surface with sufficient room to support a plurality of cups or other substance collection devices. The counter surface 109 can be located below the one or more product dispensing chutes such that a cup and/or other substance collection device is capable of being placed on top of the counter surface 109 and below the product dispensing chute 104. The counter surface can include a dispensing device that is configured to dispense one or more of a group comprising knives, forks, straws, and condiments located on the counter surface.

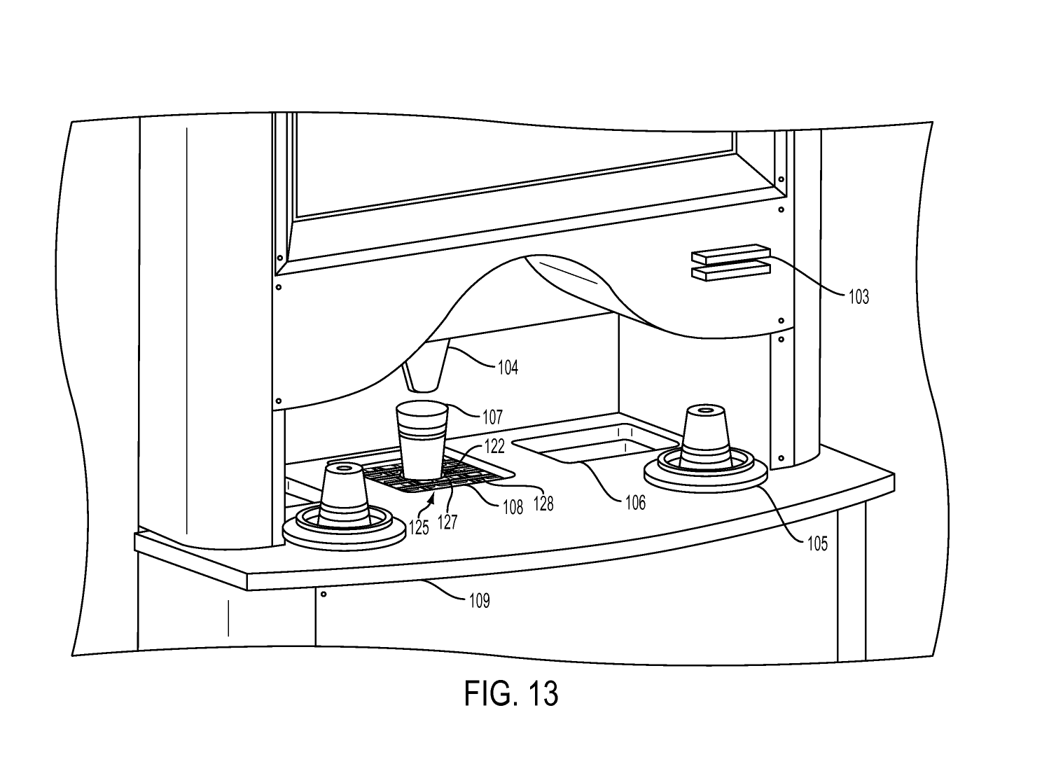

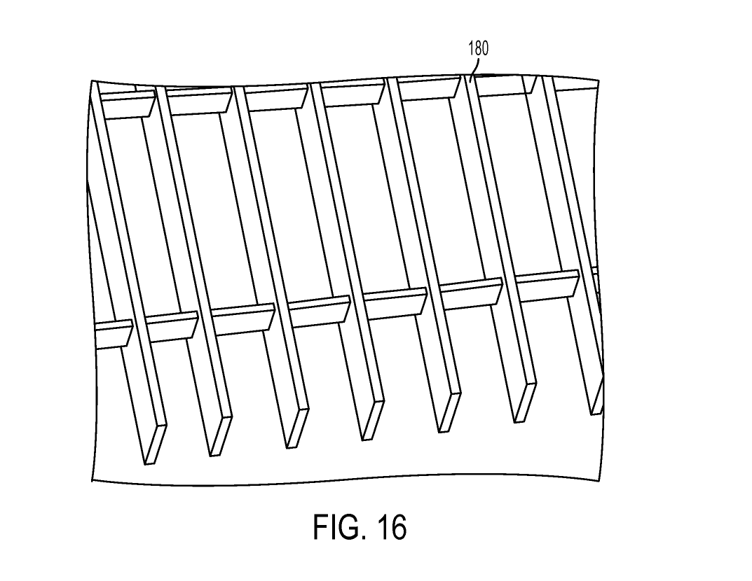

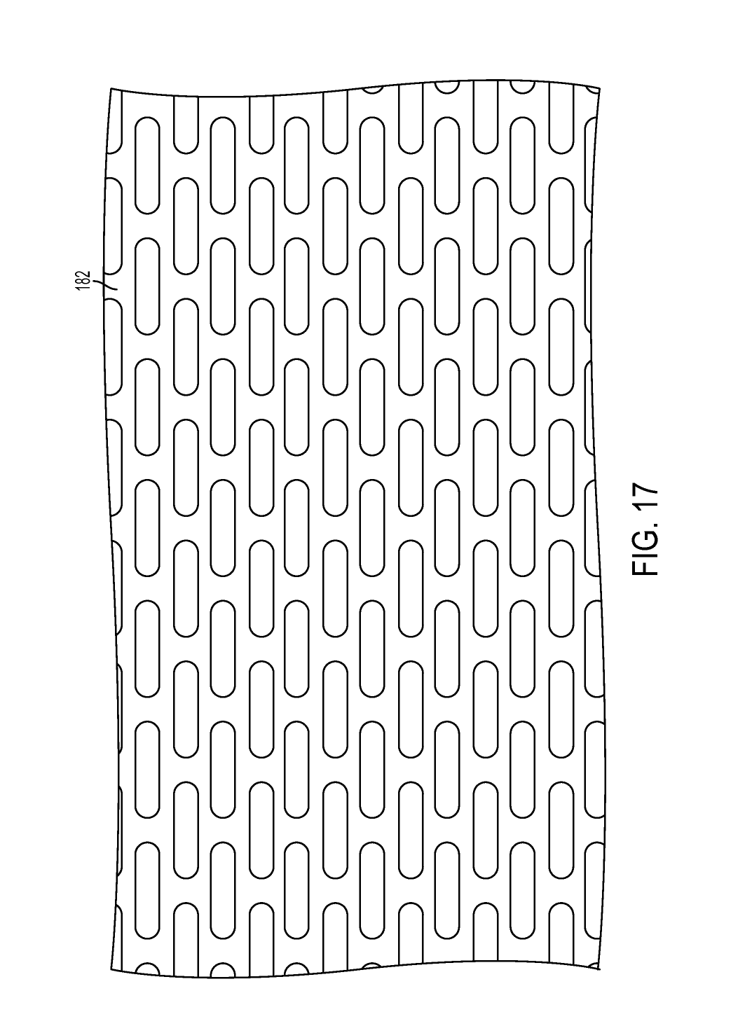

Referring to FIG. 13, the counter surface 109 can include a dispenser drain area 125 within a predetermined distance under the product dispensing chute 104. The dispenser drain area 125 can include a recessed area 122 for stable placement of a cup during dispensing. The dispenser drain area 125 can include a dispenser drainage grill 126 that can have perforations for spilled product to drain. The dispenser drainage grill 126 can include a top grill layer 127 and a bottom grill layer 128. The top grill layer 127 can be embedded in the countertop and can outline gaps in the grill so that the highly viscous product can fall through the countertop layer and onto the bottom grill layer 128. The bottom grill layer 128 can outline perforations that are smaller or finer than the gaps of the top grill layer 127. Thus, the bottom grill layer 128 can have smaller gaps than the top grill layer 127 so that melted product can drip through and drain into the waste tank, while guarding against bugs and other vermin from entering the machine. The top grill layer 127 can be of a metallic material and can be in a configuration as shown in FIG. 16. The bottom grill layer 128 can be of a material and can be in a configuration as shown in FIG. 17.

The user by touching the digital touch screen 102 to indicate the type and amount of liquid and/or frozen confections desired can cause the digital touch screen 102 to send instructions to the computer 110. Upon receiving the instructions, the computer 110 can cause the type and amount of liquid/frozen confection desired by the user to be discharged from the product dispensing chute through the computer's control of the manually operated machine 111, the one or more actuators 112, causing them to operate the machine to dispense product via the one or more dispensing mechanisms 113.

FIG. 13 shows a recessed area 122 for the cup in the dispenser drain area 125. The recessed area 122 for the cup on the dispenser drain area 125 can provide stability for a cup when product falls from the product dispensing chute 104 into the cup. Without a recessed area 122 for the cup to fit into, the falling product can push the cup off the dispenser drain area 125 and digital scale 108 or even make the cup topple over. The recessed area 122 for the cup to fit into can stabilize the cup during the dispensing process.

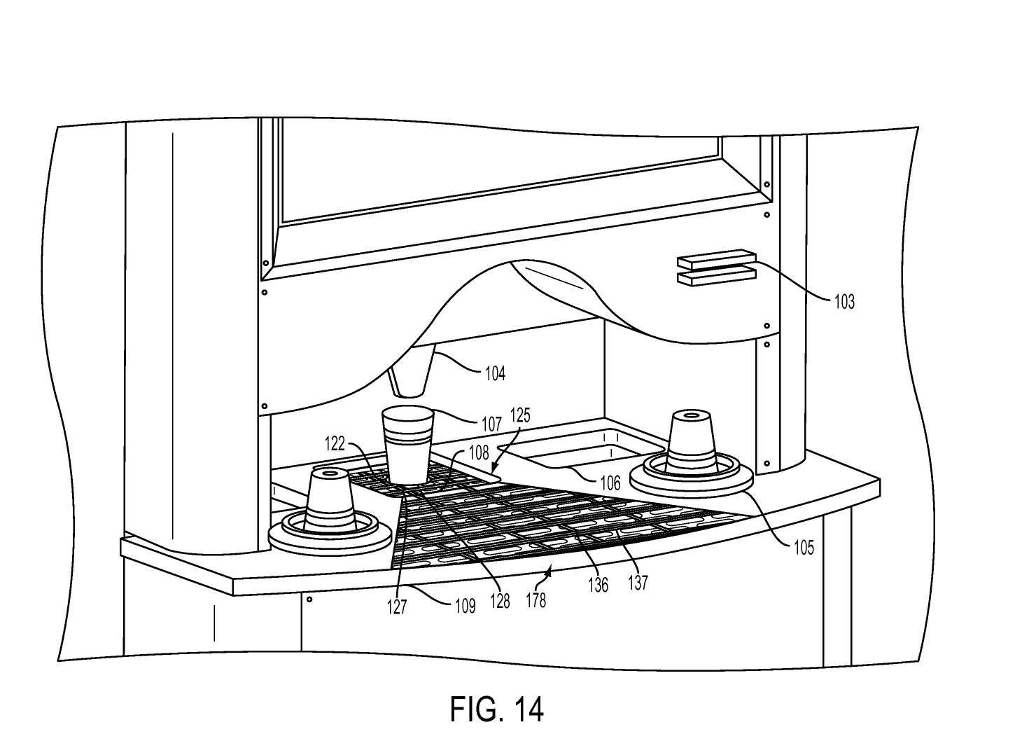

The counter surface 109 can include a countertop drainage grill 178 that extends beyond the drain pan area 108. The countertop drainage grill 178 can include a top grill layer 136 and a bottom grill layer 137, where the top grill layer 136 can have larger gaps or apertures than the bottom grill layer 137. FIG. 14 shows a countertop drainage grill 178. The countertop drainage grill 178 can be added towards the front of the counter surface 109 to span the area most likely to experience spilled product. The two-tiered configuration of the drainage grills provides for advantages relating to the product drainage. For example, the viscosity of the product is such that small hole perforations are inadequate for the product to seep through and drain in a reasonable time without larger perforations. Thus, the countertop drainage grill can include a top grill layer outlining gaps in between structural elements and a bottom grill layer outlining perforations that are smaller than the gaps of the top grill layer.

In some embodiments the dispenser drainage grill 126 can have a top grill layer and a bottom grill layer. In other embodiments, the dispenser drainage grill can have either a top grill layer and no bottom grill layer or a bottom grill layer and no top grill layer. Further, while in some embodiments, the countertop drainage grill 178 can have a top grill layer and a bottom grill layer, in other embodiments, the countertop drainage grill can have either a top grill layer and no bottom grill layer or a bottom grill layer and no top grill layer. The dispenser drainage grill 126 and/or the countertop drainage grill 178 can have openings for ventilation of the manually operated machine in the housing 101. For example, the dispenser drainage grill 126 and/or the countertop drainage grill 178 can be at least 8 mesh (8 stands per 1 in [25 mm]), or equivalent, to be used on openings to areas housing the manually operated machine having condensing units. Thus, since the machine 190 can house a self-contained refrigeration unit within the overall unit construction, the screening through the various grills can be at least 8 strands per inch. The dispenser drainage grill and the countertop drainage grill can allow for ventilation of the at least one manually operated machine.

FIG. 16 shows a zoomed-in view of a top drainage grill 180. The material can be made of metal and can be in a general rectangular criss-cross pattern. FIG. 17 shows a zoomed-in view of a bottom grill 182. The material can be made of metal and can be in a configuration of distributed oval-shaped perforations in a sheet.

The machine 190 can further include a waste tank 150 disposed on the interior surface 130 of the housing 101 underneath the drain pan area 108 and the countertop drainage grill 178. Product spilled on the countertop and drained through the grill will drain into the waste tank, illustrated in FIG. 15, which shows a waste tank/receptacle. In an embodiment, the housing 101 can further include a sensor to detect when the waste tank is full.

Other embodiments include Lights/LED strip placed around the card reader, cup dispenser, serving area/drain pan to guide customer through checkout process in product checkout sequence. A sensor can be used to detect when the waste tank/receptacle 150 is full. Further, an internal temperature sensor can guard against overheating of the machine 111.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

We claim:

1. A machine for dispensing liquids and/or frozen confections, comprising:
a housing that is configured to house one or more manually operated machines for dispensing drinks and/or frozen confections, the housing having an interior surface that interfaces with the one or more manually operated machines and having an exterior surface for interfacing with a user;
one or more product dispensing chutes disposed on the interior surface of the housing that is configured to receive product from one or more dispensing mechanisms of the one or more manually operated machines; and
one or more actuators that is disposed on the interior surface of the housing, the one or more actuators being configured to interact with the at least one manually operated machine and a computer programmed to accept instructions such that dispensing of one or more dispensing mechanisms of the at least one manually operated machine is automated to dispense an amount of liquid and/or frozen confections according to instructions received from the computer.

2. The machine of claim 1, further comprising a digital interface that is disposed on the exterior surface of the housing, the digital interface interfacing with the computer.
wherein when the user inputs a type and amount of liquid and/or frozen confections desired to the digital interface, the digital interface sends instructions to the computer, and the computer causes the type and amount of liquid/frozen confection desired by the user to be discharged from the product dispensing chute through control of the computer of: the manually operated machine, the one or more actuators, and the one or more dispensing mechanisms.

3. The machine of claim 2, further comprising a counter surface, which provides an approximately level surface with sufficient room to contain a plurality of cups or other substance collection devices, the counter surface being located below the one or more product dispensing chutes such that a cup and/or other substance collection device is capable of being placed on top of the counter surface and below the product dispensing chute.

4. The machine of claim 3, further comprising a holder for dispensing cups or other substance collection devices located on the counter surface.

5. The machine of claim 1, further comprising:
one or more payment devices disposed on the exterior surface of the housing; and
a payment connection device that is configured to transmit data from the payment device to the computer,
wherein a user may acquire liquid and/or frozen confectionary goods by using the payment device, which then informs the computer that payment has happened.

6. The machine of claim 1, further comprising;
a scale, which monitors the amount of liquid and/or frozen confections dispensed by the dispensing mechanism through the dispensing chute by monitoring the weight of the product; and
a scale connection device that is configured to transmit data between the scale and the computer;
wherein the scale is embedded in a counter surface and directly below the dispensing chute; and
wherein the scale sends information to the computer that the amount of liquid and/or frozen confections desired by the user has been dispensed whereby the computer causes the dispensing mechanism to stop dispensing liquid and/or frozen confections.

7. The machine of claim 1, wherein the actuator connects to a draw valve of the at least one manually operated machine.

8. The machine of claim 1, wherein the one or more actuators is a pneumatic cylinder or linear motor.

9. A method of serving drinks and/or frozen confections comprising:
housing the drinks and/or frozen confections inside a manually operated machine for dispensing drinks and/or frozen confections, the manually operated machine being located in the housing; and
wherein the housing comprises a computer, a user interface, one or more actuators, one or more product dispensing mechanisms, and one or more payment devices, and the computer is programmed with software to control the actuators and payment devices in response to instructions entered by a user on the user interface, and
wherein the user selects a type and quantity of the drinks and frozen confections the user would like.

10. The method of claim 9, wherein:
the user interface sends data to the computer, the computer performs calculations and sends instructions to other components of the housing to dispense the type and quantity of liquid and/or confections desired by the user, and
the one or more actuators open and close a dispensing mechanism on the one or more manually operated machine.

11. A machine for dispensing liquids and/or frozen confections, comprising:
a housing that is configured to house one or more manually operated machines for dispensing drinks and/or frozen confections, the housing having an interior surface that interfaces with the one or more manually operated machines and having an exterior surface for interfacing with a user;
a user interface that is disposed on the exterior surface of the housing, the user interface interfacing with a computer programmed to accept instructions from the user interface to automate dispensing;
one or more actuators disposed on the interior surface of the housing, the one or more actuators operable in response to instructions input by the user via the user interface;
for each actuator, a connection piece that is configured at its proximal end to attach to the actuator and that is configured on its distal end to receive a handle of the one or more manually operated machines such that dispensing of one or more dispensing mechanisms of the at least one manually operated machine is automated;
a product dispensing chute that is disposed on the interior surface of the housing and that is configured to receive product from the one or more dispensing mechanisms; and
wherein by the user touching the user interface to indicate a type and amount of liquid and/or frozen confections desired, the user interface sends instructions to the computer, and the computer causes the type and amount of liquid/frozen confection desired by the user to be discharged from the product dispensing chute through control of the computer of: the manually operated machine, the one or more actuators, and the one or more dispensing mechanisms.

12. The machine of claim 11, further comprising:
a counter surface, which provides an approximately level surface with sufficient room to contain a plurality of cups or other substance collection devices, the counter surface being located below the product dispensing chute; and
a drain pan area that is on the counter surface substantially under the product dispensing chute such that a cup and/or other substance collection device is capable of being placed on the drain pan area and below the product dispensing chute.

13. The machine of claim 12, wherein by the user touching the user interface to indicate a type and amount of liquid and/or frozen confections desired, the user interface sends instructions to the computer, and the computer causes the type and amount of liquid/frozen confection desired by the user to be discharged from the product dispensing chute through the computer's control of the manually operated machine, the one or more actuators, and the one or more dispensing mechanisms.

14. The machine of claim 12, wherein the counter surface includes a drain pan area within a predetermined distance under the product dispensing chute, the drain pan area including a recessed area for stable placement of a cup during dispensing, and the drain pan area having perforations for spilled product to drain.

15. The machine of claim 14, wherein the drain pan area includes a dispenser drainage grill, the dispenser drainage grill including a top grill layer outlining gaps in between structural elements and a bottom grill layer outlining perforations that are smaller than the gaps of the top grill layer.

16. The machine of claim 15, wherein the counter surface includes a countertop drainage grill that extends beyond the drain pan area, the countertop drainage grill outlining gaps for draining spilled product.

17. The machine of claim 16, wherein the countertop drainage grill includes a top grill layer outlining gaps in between structural elements and includes a bottom grill layer outlining perforations that are smaller than the gaps of the top grill layer.

18. The machine of claim 17, wherein the dispenser drainage grill and the countertop drainage grill allow for ventilation of the at least one manually operated machine.

19. The machine of claim 16, further comprising a waste tank disposed on the interior surface of the housing underneath the dispenser drainage grill and countertop drainage grill.

20. The machine of claim 19, further comprising a sensor to detect when the waste tank is full.

21. The machine of claim 11, wherein the product dispensing chute includes a plurality of chambers that converge to a single mouth over a recessed serving area.

22. The machine of claim 11, further comprising a protective barrier apparatus that creates a barrier in between the interior surface of the housing and the one or more dispensing mechanisms of the manually operated machine.

23. The machine of claim 11, further comprising:
one or more payment devices disposed on the exterior surface of the housing; and
a payment connection device that is configured to transmit data from the payment devices to the computer,
wherein a user may acquire liquid and/or frozen confectionary goods by using the payment device, which then informs the computer that payment has happened.

24. The machine of claim 23, further comprising lights placed around the one or more payment devices, cup dispenser, and drain pan area to guide the user.

25. The machine of claim 11, further comprising an internal temperature sensor to guard against overheating of the at least one manually operated machine.

26. The machine of claim 11, wherein the user interface is a digital touch screen.

27. The machine of claim 11, further comprising;
a scale, which monitors the amount of liquid and/or frozen confections dispensed by the dispensing mechanism through the product dispensing chute by monitoring the weight of the product; and
a scale connection device that is configured to transmit data between the scale and the computer;
wherein the scale is embedded in a counter surface and directly below the product dispensing chute; and
wherein the scale sends information to the computer that the amount of liquid and/or frozen confections desired by the user has been dispensed whereby the computer causes the dispensing mechanism to stop dispensing liquid and/or frozen confections.
